(19) United States
(12) Patent Application Publication
(10) Pub. No.: US 2005/0129392 A1
(43) Pub. Date: Jun. 16, 2005

(54) Image blur correction apparatus and optical apparatus

(76) Inventor: Mitsuru Shinohara, Tochigi (JP)

Correspondence Address: COWAN LIEBOWITZ & LATMAN P.C;JOHN J TORRENTE, 1133 AVE OF THE AMERICAS, 1133 AVE OF THE AMERICAS, NEW YORK, NY, 10017, US

(21) Appl. No.: 10/988,767

(22) Filed: Nov. 15, 2004

(30) Foreign Application Priority Data
Dec. 10, 2003 (JP) 2003-412525

(51) Int. Cl. G03B 17/00

(52) U.S. Cl. 396/50; 396/55

(57) ABSTRACT

Provided is an image blur correction apparatus for correcting an image blur caused by a vibration by driving an optical element, including: a vibration detector for detecting the vibration; a diving mechanism for driving the optical element; a controller for controlling the driving mechanism based on an output of the vibration detector; and a posture detector for detecting a posture of the apparatus, in which the controller changes driving characteristic of the driving mechanism in accordance with an output of the posture detector. The present invention provides an image blur correction apparatus which can improve driving characteristic of a correction optical system in a hand vibration frequency domain irrespective of a direction in which a force of gravity is applied.

### BACKGROUND OF THE INVENTION

1. Field of the Invention

The present invention relates to an image blur correction apparatus which is mounted on an optical apparatus such as a camera to correct image blur.

2. Related Background Art

In a camera, nowadays, since operations such as exposure determination and focusing important for photographing are all automated, a possibility that those unskilled in camera operation will fail in photographing has greatly been reduced. Additionally, studies have recently been conducted on a system which corrects image blurs caused by hand shakes applied to the camera. Accordingly, there are now almost no factors to cause photographers to fail in photographing.

Now, the system that corrects image blurs caused by hand shakes will be described briefly. A hand shake of the camera during photographing is normally a vibration with a frequency 1 Hz to 12 Hz. To enable photographing free of image blur even when the hand shake occurs at the time of shutter release operation, a camera shake (i.e., acceleration, a speed, or the like) due to the hand shake must first be detected accurately. Then, an optical axis change caused by the camera shake needs to be corrected by displacing a correction lens in accordance with a result of the detection.

FIG. 5 is a perspective view showing a schematic configuration of a conventional system for correcting image blurs (image blur correction apparatus including a correction optical unit, a vibration detection sensor, and the like), i.e., the system that corrects image blues caused by a camera vertical vibration indicated by an arrow 81p in FIG. 5 and a camera horizontal vibration indicated by an arrow 81y (see Japanese Patent Application Laid-Open No. 5-215992).

Specifically, according to the conventional system, a correction optical device 85 (including coils 87p, 87y for applying thrusts to a correction lens, and position detection elements 86p, 86y for detecting a position of the correction lens) is driven toward outputs of vibration detection sensors 83y, 83p for detecting the vertical and horizontal vibration of the camera, respectively, (vibration detection directions are indicated by arrows 84p, 84y) as target values to correct image blurs on an image plane 88.

FIG. 6 is a conceptual block diagram illustrating conventional image blur correction control.

In FIG. 6, when a target positional signal (vibration signal) dIN is input, force factors K containing amplification gains are integrated by an operation unit, and a result is output as a driving signal F to drive the correction optical system to a target position to the correction optical device. When the correction optical system is driven by the driving signal F, a mechanical integration operation in the correction optical device generates an acceleration signal a, a speed signal v, and a displacement signal dOUT.

In the correction optical device, a viscous force C corresponding to a frictional force and a speed is reversed and input to an addition point P2 to form a feedback loop. In the operation unit, the displacement signal dOUT is reversed and input to an addition point P1 to form a feedback loop. In other words, it is possible to change driving characteristic of the correction optical system by changing the amplification gain to change the force factor K and changing the driving signal F.

Now, from the conceptual block diagram of FIG. 6, a gain (amplitude ratio of the output signal dOUT to the input signal dIN) and a phase (phase delay of the output signal dOUT to the input signal dIN) are represented by the following equations.

$$\begin{matrix}Gain : \vert G ( j ω ) \vert = \frac{K}{\sqrt{{( K - m {ω}^{2} )}^{2} + {( C ω )}^{2}}} & ( 1 ) \\ Phase : ∠G ( j ω ) = {tan}^{- 1} \frac{- C ω}{K - m {ω}^{2}} & ( 2 )\end{matrix}$$

As apparent from the equations (1) and (2), a gain becomes smaller and a phase delay becomes larger as the viscous force C corresponding to the frictional force and the speed in the correction optical device become larger. Additionally, when an amplification gain is increased to increase the force factor K, a resonance frequency is shifted toward a high frequency side, a gain becomes larger, and a phase delay becomes small. In other words, driving characteristic is improved.

FIGS. 7A and 7B are diagrams illustrating characteristics of the conventional image blur correction apparatus in which FIG. 7A shows a gain (amplitude ratio of the output signal dOUT to the input signal dIN), and FIG. 7B shows a phase (phase delay of the output signal dOUT with respect to the input signal dIN).

In FIG. 7A, reference numeral 101 denotes gain characteristic when the image blur correction apparatus is in a horizontal state (state in which a gravity direction is orthogonal to an optical axis), and reference numeral 102 denotes gain characteristic when the image blur correction apparatus is in an upward facing state (state in which a gravity direction is the same as an optical axial direction). In FIG. 7B, reference numeral 103 denotes phase characteristic when the image blur correction apparatus is in the horizontal state, and reference numeral 104 denotes phase characteristic when the image blur correction apparatus is in the upward facing state.

As apparent from the drawings, driving characteristic is worse in the upward facing state of the image blur correction apparatus than those in the horizontal state.

That is, in the upward facing state of the image blur correction apparatus, a frictional force between a support pin for supporting the correction optical system and a member engaged with the support pin is increased. Thus, a force (viscous force C) reversed to a driving force and input in the correction optical system is increased. Thus, as apparent from the equations (1) and (2), driving characteristic of the correction optical system is deteriorated.

Accordingly, to improve the driving characteristic, the amplification gain may be increased to increase the driving force applied to the correction optical device.

FIGS. 8A and 8B are diagrams illustrating characteristics of a gain (amplitude ratio of the output signal dOUT to the input signal dIN) (FIG. 8A) and characteristics of a phase (phase delay of the output signal dOUT with respect to the input signal dIN) (FIG. 8B) when amplification gains are uniformly increased in the horizontal state of the image blur correction apparatus.

In FIG. 8A, gain characteristic denoted by reference numeral 101 are equivalent to the gain characteristic of FIG. 7A, and reference numeral 105 denotes gain characteristic when the amplification gain is increased in the horizontal state of the image blur correction apparatus. In FIG. 8B, phase characteristic denoted by reference numeral 103 are equivalent to the phase characteristic of FIG. 7B, and reference numeral 106 denotes phase characteristic when the amplification gain is increased in the horizontal state of the image blur correction apparatus.

As apparent from the drawings, irrespective of whether the image blur correction apparatus is in the horizontal state or upward facing state, when the amplification gain is increased, in the horizontal state in which the frictional force is small between the support pin for supporting the correction optical system and the member engaged with the support pin, the force factor K is increased while a term C of the frictional force is small as can be understood from the equations (1) and (2). Thus, the resonance frequency is shifted toward the high frequency side, and a peak of a gain in a resonance frequency band becomes excessively high, causing a problem of oscillation.

### SUMMARY OF THE INVENTION

It is therefore an object of the present invention to provide an image blur correction apparatus which can improve driving characteristic of a correction optical system in a hand shake frequency domain irrespective of a direction in which a force of gravity is applied.

According to one aspect of the invention, an image blur correction apparatus for correcting an image blur caused by a vibration by driving an optical element, includes: a vibration detector for detecting the vibration; a diving mechanism for driving the optical element; a controller for controlling the driving mechanism based on an output of the vibration detector; and a posture detector for detecting a posture of the apparatus, in which the controller changes a driving characteristic of the driving mechanism in accordance with an output of the posture detector.

In further aspect of the invention in the image blur correction apparatus, the posture detector detects the posture of the apparatus in a gravity direction.

In further aspect of the invention in the image blur correction apparatus, the controller generates a driving signal for driving the driving mechanism based on a vibration signal obtained from the output of the vibration detector and amplification gain data, and changes a value of the amplification gain data in accordance with the output of the posture detector.

In further aspect of the invention in the image blur correction apparatus, the controller increases a value of amplification gain data as a resistance force generated in the driving mechanism against driving of the optical element is larger with respect to the output of the posture detector.

In further aspect of the invention in the image blur correction apparatus, the apparatus further includes a memory which stores an amplification gain value according to the posture of the apparatus, and the controller reads the amplification gain value according to the output of the posture detector from the memory.

In further aspect of the invention in the optical apparatus for correcting an image blur caused by a vibration by driving an optical element, the apparatus further includes: a driving mechanism which drives the optical element; a controller which controls the driving mechanism based on an output of a vibration detector which detects the vibration; and a posture detector which detects a posture of the optical apparatus, and the controller changes a driving characteristic of the driving mechanism in accordance with an output of the posture detector.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing circuitry of an interchangeable lens and a camera on which an image blur correction apparatus according to a first embodiment of the invention is mounted;

FIG. 2 is comprised of FIGS. 2A and 2B showing flowcharts illustrating a series of operations in a camera system according to the first embodiment of the present invention;

FIGS. 3A and 3B are diagrams illustrating characteristics of the image blur correction apparatus according to the first embodiment of the present invention;

FIG. 4 is a sectional view showing a schematic configuration of a correction optical unit;

FIG. 5 is a perspective view showing a schematic configuration of a conventional image blur correction system;

FIG. 6 is a conceptual block diagram of conventional image blur correction control;

FIGS. 7A and 7B are diagrams illustrating characteristics of a conventional image blur correction apparatus;

FIGS. 8A and 8B are diagrams illustrating characteristics when amplification gains are uniformly increased in the conventional image blur correction apparatus;

FIG. 9 is a view showing a structure of an acceleration sensor for detecting a gravity direction according to the first embodiment of the present invention; and

FIG. 10 is a view showing a relation between a detection axis of the acceleration sensor and a force of gravity.

### DESCRIPTION OF THE PREFERRED EMBODIMENTS

Next, preferred embodiments of the present invention will be described.

### First Embodiment

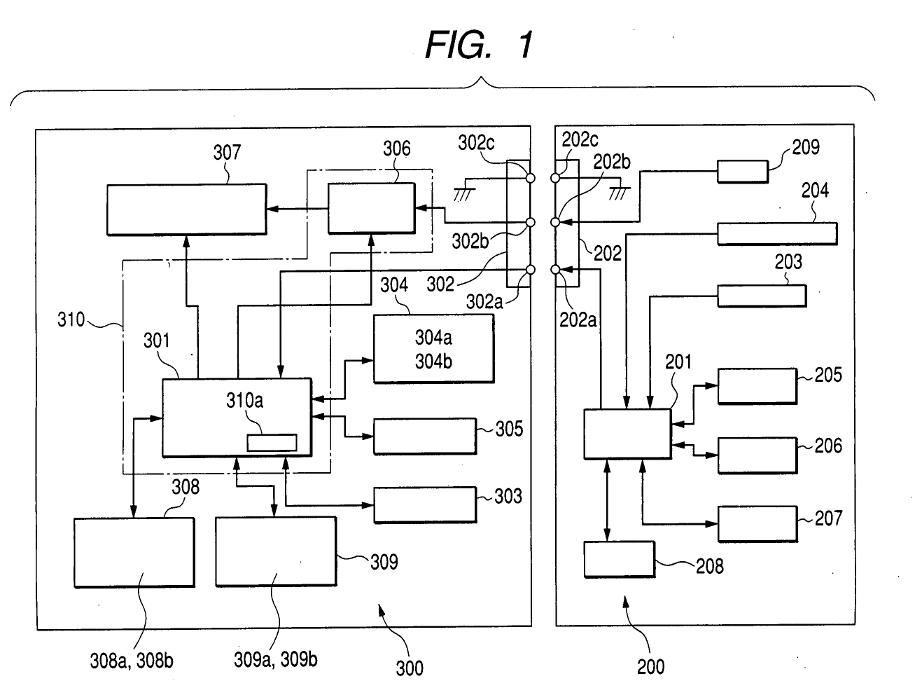

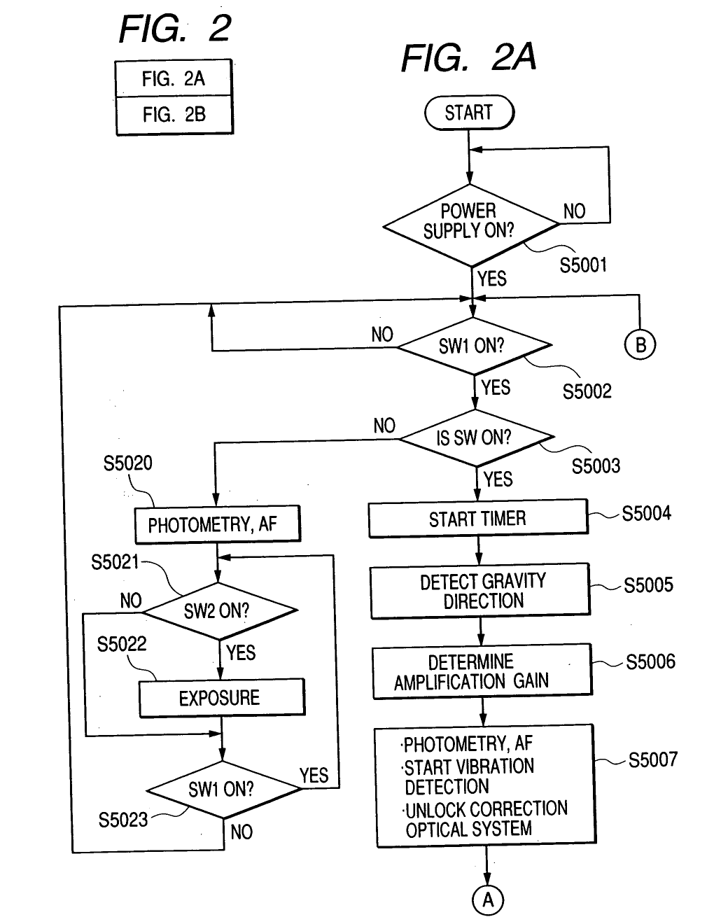

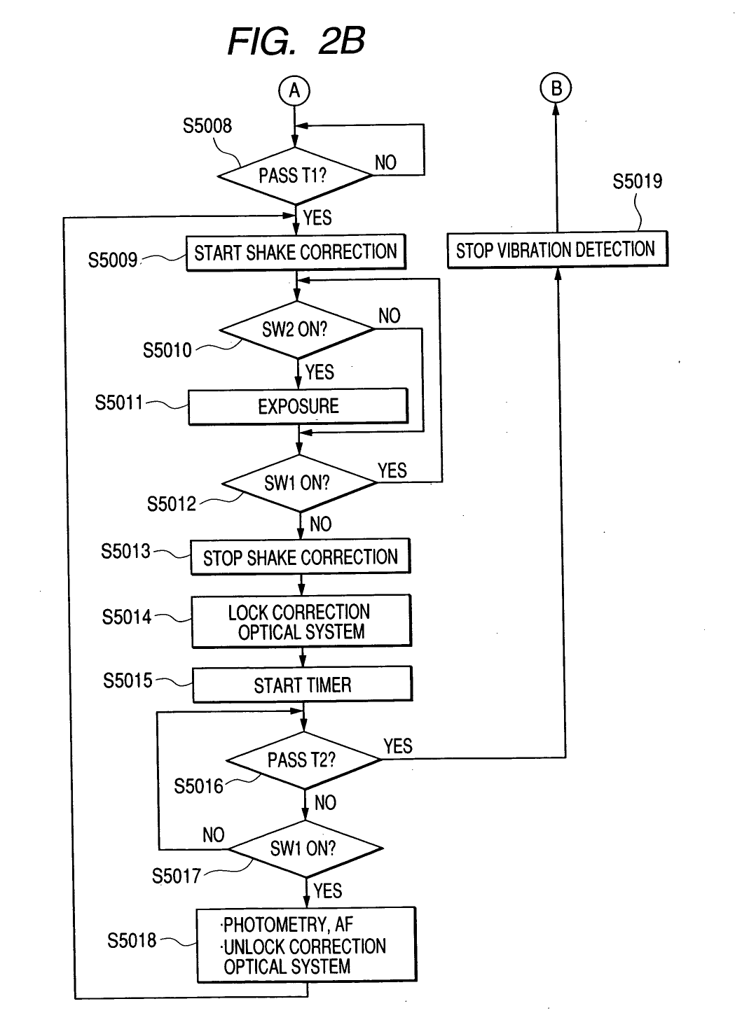

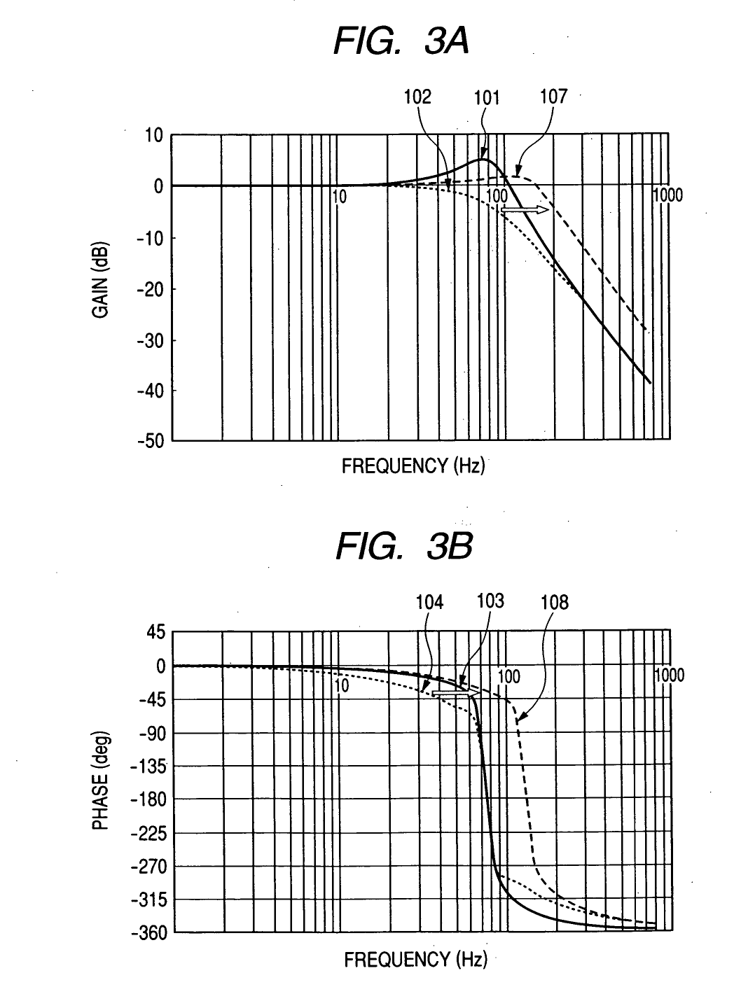

FIG. 1 is a block diagram showing circuitry of a camera system which includes an interchangeable lens, on which an image blur correction apparatus of a first embodiment of the invention is mounted, and a camera having the interchangeable lens detachably attached thereto. FIGS. 2A and 2B are flowcharts showing a series of operations (photographing operations) in the camera system of this embodiment. FIGS. 3A and 3B are diagrams illustrating characteristics of the image blur correction apparatus of this embodiment.

In FIG. 1, reference numeral 200 denotes a camera, and 300 denotes an interchangeable lens. First, a configuration of the camera 200 will be described.

Reference numeral 201 denotes a camera CPU constituted by a microcomputer. As described later, the camera CPU 201 controls operations of various circuits integrated in the camera 200, and communicates with a lens CPU 301 through a camera contact group 202 when the interchangeable lens 300 is mounted on the camera 200.

The camera contact group 202 includes a signal transmission contact 202a for transmitting and receiving a signal to and from the interchangeable lens 300, a power supply contact 202b for supplying power from a power source 209 on the camera 200 side to the interchangeable lens 300 side, and a ground contact 202c connected to the interchangeable lens 300 side and grounded.

Reference numeral 203 denotes a power supply switch operable from the outside. When the power supply switch 203 is switched on, the camera CPU 201 is started to supply power to actuators, sensors, circuits, and the like in the camera system, whereby the camera system becomes operable.

Reference numeral 204 is a 2-stage stroke type releasing operation member operable from the outside, and an output signal thereof is input to the camera CPU 201.

The camera CPU 201 carries out a photographing preparation operation when a switch SW1 that responds to a first stroke operation of the releasing operation member 204 is ON. For the photographing preparation operation, for example, the camera CPU 201 controls driving of a photometric circuit 205 to measure a luminance of a subject, and calculates an exposure value based on a result of the measurement. The camera CPU 201 controls driving of a focus detection circuit 208 (described later) to detect a focus adjustment state of a photographing optical system, and controls driving of a focusing lens disposed in the interchangeable lens 300 based on a result of the detection to set the photographing optical system in a focused state.

On the other hand, when a switch SW2 that responds to a second stroke operation is switched on, the camera CPU 201 transmits a signal regarding an aperture stop operation command (described later) to the lens CPU 301 (the lens that controls operations of various circuits and units disposed in the interchangeable lens 300 and communicates with the camera CPU 201 through a lens contact group 302 when the interchangeable lens 300 is mounted on the camera 200) in the interchangeable lens 300. The camera CPU 201 transmits a signal regarding an exposure starting command (i.e., a shutter speed or the like) to an exposure circuit 206 to execute an exposure operation (exposure to a film by an opening/closing operation of a shutter (not shown)). Upon reception of an exposure end signal from the exposure circuit 206, the camera CPU 201 transmits a feed starting command to a feeding circuit 207 to wind the film by one frame.

This embodiment has been described by way of the camera 200 which uses the film. In place of the film, however, an imaging device such as a CCD or a CMOS image sensor can be used.

Reference numeral 208 is a focus detection circuit. The focus detection circuit 208 detects a focus adjustment state of the photographing optical system with respect to the subject corresponding to a focus detection area disposed in a photographing screen in accordance with the focus detection starting command sent from the camera CPU 201 when the switch SW1 is switched on, and determines a moving amount of the focusing lens necessary for setting the photographing optical system in a focused state based on a result of the detection. Information regarding the moving amount of the focusing lens is transmitted to the camera CPU 201.

Next, a configuration of the interchangeable lens 300 will be described.

Reference numeral 302 is a lens contact group disposed in the interchangeable lens 300. The lens contact group 300 includes a signal transmission contact 302a for transmitting and receiving a signal to and from the camera 200, a power supply contact 302b for receiving power from the camera 200 side, and a ground contact 302c connected to the camera 200 side and grounded.

Reference numeral 303 denotes an IS switch operable from the outside which selects whether an image blur correcting operation (or IS operation) (described later) is executed or not, and can set the IS operation in an ON state.

Reference numeral 304 denotes a vibration detection unit (vibration detection means). The vibration detection unit 304 includes a vibration detection portion 304a which detects a vertical vibration (vibration in a pitch direction) and a horizontal vibration (vibration in a yaw direction) of the camera 200 (camera system) as an acceleration, a speed, or the like in accordance with a command from the lens CPU 301, and an operation output portion 304b which outputs a vibration signal indicating a displacement obtained by electrically and mechanically integrating an output signal of the vibration detection portion 304a to the lens CPU 301.

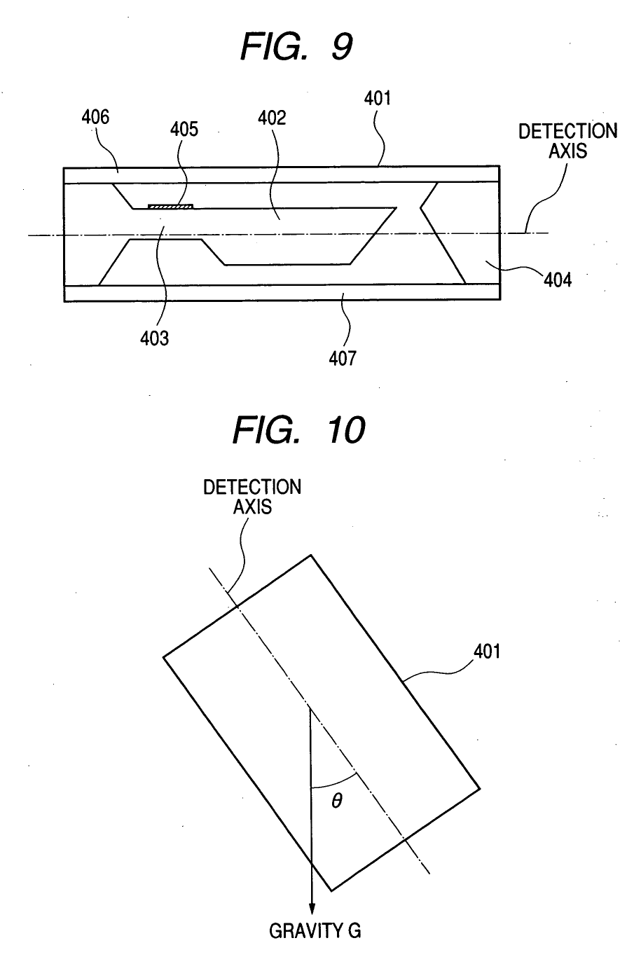

Reference numeral 305 denotes a posture sensor (posture detection means) which consists of, for example, an acceleration sensor, and detects a gravity direction of the camera (camera system). The posture sensor 305 detects the gravity direction of the camera in accordance with a command from the lens CPU 301, and outputs a result thereof to the lens CPU 301. A method of detecting a posture by the acceleration sensor will be described later with reference to FIGS. 9 and 10.

Reference numeral 306 denotes an amplification gain variable circuit. The amplification gain variable circuit 306 reads an amplification gain value corresponding to a gravity detection value (output of the posture sensor 305) from an amplification gain table prestored in a memory 301a of the lens CPU 301, and sets this value as an amplification gain in a force factor when generating a driving signal input to a correction optical unit 307 (FIG. 6).

According to this embodiment, the memory 301a is incorporated in the lens CPU 301. However, the memory 301a may be disposed separately from the lens CPU 301. According to this embodiment, the amplification gain value corresponding to the gravity detection value is read from the amplification gain table prestored in the memory 301a. However, an amplification gain value corresponding to the gravity detection value may be obtained therefrom by calculation. However, the processing speed can be increased by reading the amplification gain value corresponding to the gravity detection value from the amplification gain table.

A controller 310 equivalent to control means described in the claims is constituted by the lens CPU 301 and the amplification gain variable circuit 306.

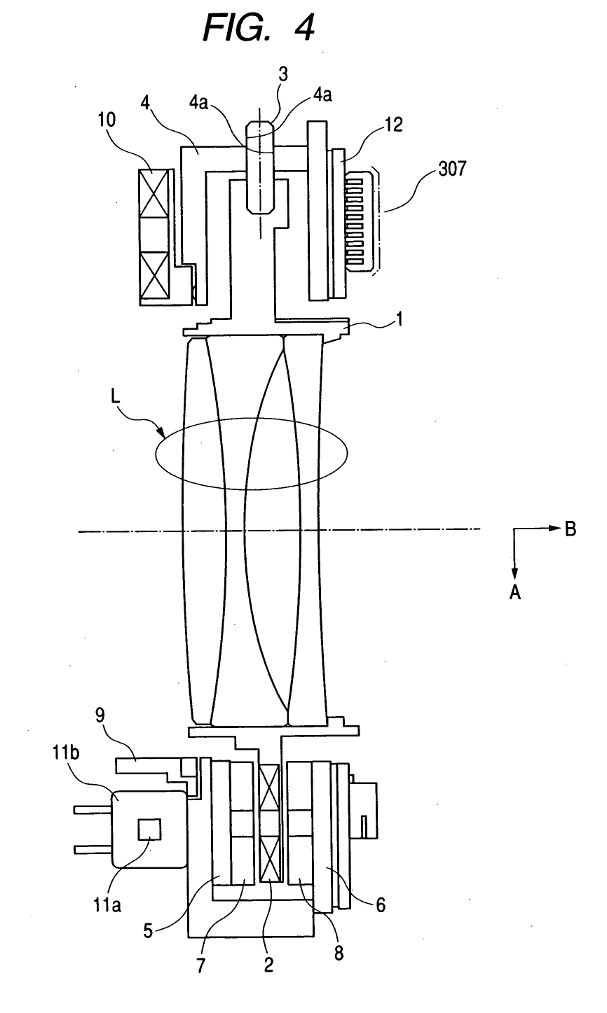

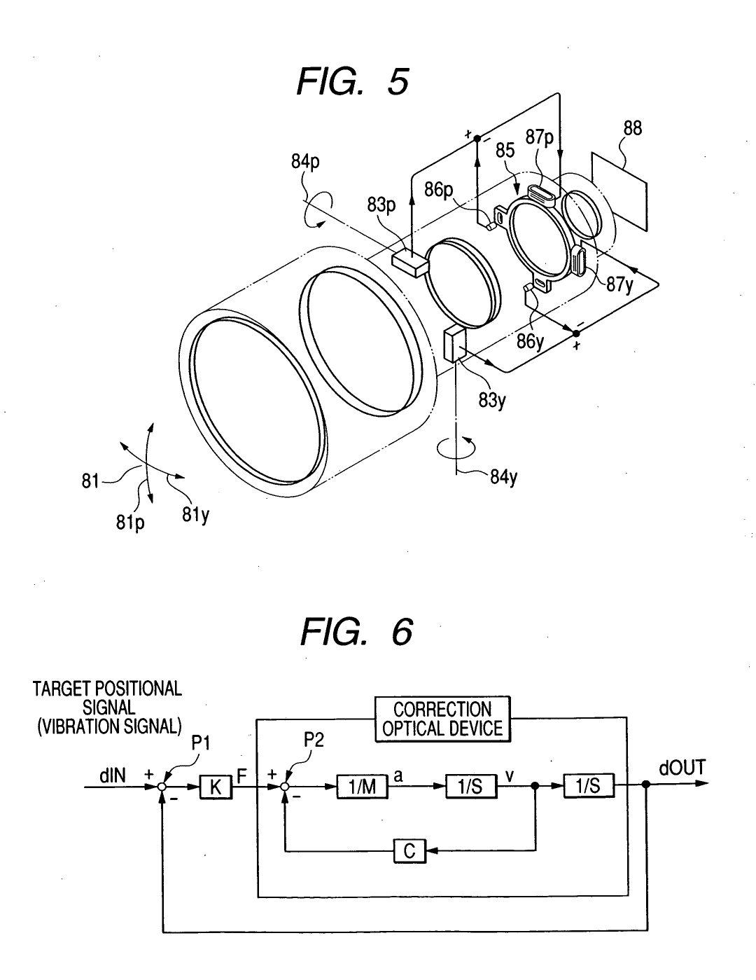

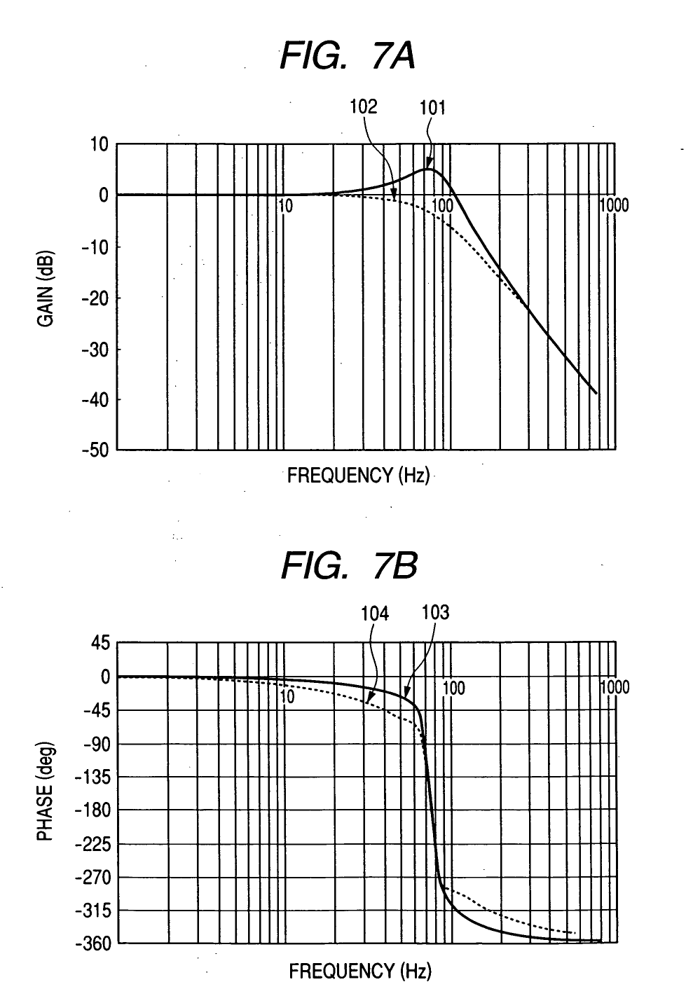

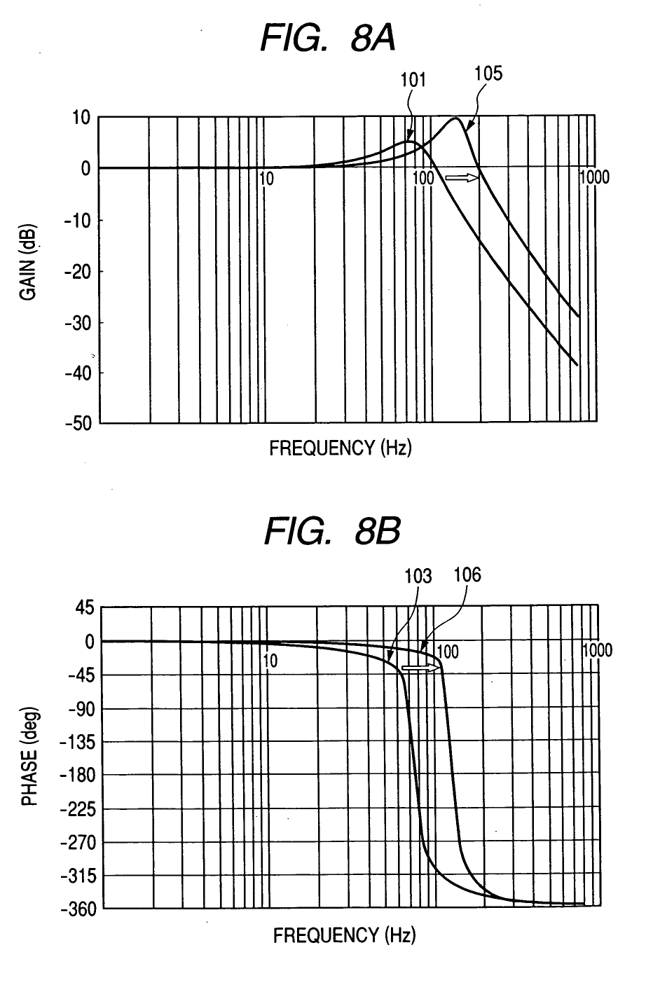

Reference numeral 307 denotes a correction optical unit. As shown in FIG. 4, the correction optical unit 307 includes a correction lens L, a support frame 1, and permanent magnets 7 and 8, yokes 0.5 and 6, and a coil 2 for driving the correction lens L in pitch and yaw directions. Now, a configuration of the correction optical unit 307 will be descried with reference to FIG. 4. FIG. 4 is a sectional view showing a schematic configuration of the correction optical unit 307.

Referring to FIG. 4, symbol L denotes a correction lens (optical element) arranged in the photographing optical system. Reference numeral 1 denotes the support frame for supporting the correction lens L, and the coil 2 is fixed to the support frame 1 through adhesion or the like. In the support frame 1, for example, support pins 3 are fixed to three positions at equal angular intervals in a circumferential direction of the support frame 1 by a fixing method such as press fitting.

Each support pin 3 is engaged with a cam hole 4a formed in a base board 4 (described later) to prevent displacement of a unit constituted by the correction lens L, the support frame 1, and the coil 2 in an optical axis direction, and to support the unit to be operable within a plane orthogonal to an optical axis. As it is supported by the support frame 1, the correction lens L is supported on the base board 4 through the support pins 3 disposed in the support frame 1. Then, by a driving mechanism constituted of the permanent magnets 7 and 8, the yokes 5 and 6, and the like, the correction lens L and the support frame 1 are driven in the pitch and yaw directions to correct an image blurs.

Reference numeral 4 denotes the base board, on which the yokes 5 and 6 attracted by the permanent magnets 7 and 8 are fixed by screws or the like to surfaces opposed to the coil 2. Reference numeral 9 denotes a lock ring rotatably supported on the base board 4. A coil 1b is fixed to the lock ring 9 through adhesion or the like.

Reference numerals 11a and 11b denote an adsorption yoke and an adsorption coil which are fixed to the base board 4 by screws or the like. When no power is supplied to the coil 10 and the adsorption coil 11b, the lock ring 9 is rotated in a direction for locking the support frame 1 spring-biased by a charge spring (not shown). A locking projection portion (not shown) disposed on the lock ring 9 and a locking projection portion of the support frame 1 are engaged with each other, whereby the support frame 1 is locked in position (positioned) with respect to the base board 4.

On the other hand, when power is supplied to the coil 10, the yokes disposed in the surface opposed to the coil 10 and attracted by permanent magnets (not shown), and the like, the lock ring 9 is rotated in a direction for unlocking the locked state with respect to the support frame 1, whereby the locking projection portion (not shown) in the lock ring 9 and the locking projection portion of the support frame 1 are disengaged from each other. Thus, the support frame 1 becomes operable.

In this case, when power is supplied to the adsorption coil 11b, the adsorption yoke 11a adsorbs a metal piece (not shown) disposed in the lock ring 9, whereby the lock ring 9 is maintained in an unlocked state.

Reference numeral 12 denotes a printed board, on which a PSD for detecting a position of the correction lens L and various electric elements are mounted.

Referring to FIG. 1, reference numeral 308 denotes a focusing unit. The focusing unit 308 includes a focusing lens 308b movable in the optical axis direction, and a control circuit 308a which controls driving of the focusing lens 308b based on an output (corresponding to the moving amount of the focusing lens sent from the camera CPU 201) of the lens CPU 301.

Reference numeral 309 denotes a stop unit. The stop unit 309 includes a stop member 309b which forms an opening area of light passage in the interchangeable lens 300, and a control circuit 309a which controls driving of the stop member 309b based on an output (corresponding to stop information sent from the camera CPU 201) of the lens CPU 301.

Next, an operation of the camera system of this embodiment (operations of the camera CPU 201 and the lens CPU 301) will be described with reference to the flowchart of FIG. 2.

First, in a step S5001, the camera CPU 201 judges whether the power supply switch 203 is on or not. If the result shows that the power supply switch 203 is on, power is supplied from the power source 209 of the camera 200 to the electric components in the camera 200 and to the interchangeable lens 300, and communication is started between the camera 200 and the interchangeable lens 300.

In this case, when a new battery is mounted on the camera 200 or when the interchangeable lens 300 is mounted on the camera 200, power is supplied from the power source 209 of the camera 200 to the interchangeable lens 300, and communication is started between the camera 200 and the interchangeable lens 300.

Upon the start of the communication between the camera 200 and the interchangeable lens 300 as described above, in a step S5002, the camera CPU 201 stands by until the switch SW1 becomes on by the first stroke of the releasing operation member 204, and proceeds to a step S5003 after the switch SW1 switched on.

In the step S5003, the lens CPU 301 judges whether the IS switch 303 is on (IS operation selected) or not. If the IS operation has been selected, the process proceeds to a step S5004. If the IS operation has not been selected, the process proceeds to a step S5020.

In the step S5004, the lens CPU 301 starts an internal timer. In a step S5005, a gravity direction of the camera system is detected through the posture sensor 305.

In a step S5006, an amplification gain is determined based on the gravity direction obtained in the step S5005. Specifically, based on the output (gravity detection value) of the posture sensor 305, an amplification gain value corresponding to the gravity detection value is read from the amplification gain table prestored in the memory 301a of the lens CPU 301, and this value is set as an amplification gain in a force factor when generating a driving signal input to the correction optical unit 307.

In other words, as the influence of a force of gravity applied on the correction optical unit 307 is increased (e.g., when the camera system is shifted from the horizontal state to the upward facing state), an amplification gain is increased stepwise, and a driving force of the correction optical unit 307 is increased stepwise. Thus, according to this embodiment, the amplification gain is increased stepwise in accordance with the influence of the force of gravity applied on the correction optical unit 307, whereby it is possible to prevent an increase of a gain peak value which occurs when amplification gains are uniformly increased as in the conventional case. Furthermore, by stepwise increasing the amplification gain in accordance with the influence of the force of gravity, gain characteristic and phase characteristic can be obtained in accordance with the influence of the force of gravity, and good driving characteristics can be obtained.

In a step S5007, the camera CPU 201 drives the photometric circuit 205 and the focus detection circuit 208 to obtain photometric information and focus adjustment information of the photographing optical system. The lens CPU 301 communicates with the camera CPU 201 to receive the focus adjustment information described above, and drives the focusing unit 308 based on the focus adjustment information to execute a focusing operation.

Further, the lens CPU 301 starts vibration detection for the camera system through the vibration detection unit 304. The lens CPU 301 also drives the correction optical unit 307, making it ready for the shake operation. In other words, the engagement between the lock ring 9 and the support frame 1 is released by supplying power to the coil 10 and the adsorption coil 11b as shown in FIG. 4, whereby the correction lens L becomes operable within the plane orthogonal to the optical axis.

In a step S5008, the lens CPU 301 judges whether the time clocked by the timer has reached a predetermined time T1 or not, and stands by in this step until the time T1 is reached. This is for the purpose of securing a time until an output of the vibration detection unit 304 is stabilized.

After a passage of the predetermined time T1, in a step S5009, based on a target value signal from the output of the vibration detection unit 304 (operation output portion 304b) and an output of the position detection sensor (PSD or the like described above) disposed in the correction optical unit 307, the lens CPU 301 starts control of driving of the correction optical unit 307 within a current value range set for each driving direction (pitch direction or yaw direction) by the amplification gain variable circuit 306, i.e., shake correction control by driving of the correction lens L.

In a step S5010, the camera CPU 201 judges whether the switch SW2 that responds to the second stroke operation of the releasing operation member 204 is on or not. The process proceeds to a step S5011 if the switch SW2 is in an on state, and to a step S5012 if it is in an off state.

In the step S5011, the lens CPU 301 controls driving of the stop unit 309 to set the diameter of an opening formed by the stop member 309b, and the camera CPU 201 controls driving of the exposure circuit 206 to execute an exposure operation on a film. Incidentally, in the case of using an imaging device, the light of a subject is received by the imaging device, electric charges corresponding to the amount of the received light are stored, and then the stored electric charges are read. The read signal is subjected to predetermined processing (e.g., color processing) by a signal processing circuit disposed in the camera 200, and displayed as a photographed image in a display portion disposed in the camera 200, or recorded in a recording medium.

In this case, during the exposure operation of the step S5011, the correction lens L moves in the plane orthogonal to the optical axis in the shake correction optical unit 307, whereby an image blurs caused by a vibration applied to the camera system is corrected.

In the step S5012, judgment is made again as to whether the switch SW1 is on or not. The process returns to the step S5010 if the switch SW1 is in an on state, and to a step S5013 if it is in an off state.

In the step S5013, the lens CPU 301 stops the shake correction control. In a step S5014, the power supplied to the coil 10 and the adsorption coil 11 is cut off to engage the lock ring 9 with the support frame 1, and to hold the correction lens L of the correction optical unit 307 in a predetermined position (optical axis center position).

Upon completion of the exposure operation in the aforementioned manner, in the step S5012, the camera CPU 201 judges an on/off state of the switch SW1, and the process proceeds to the step S5013 if the switch SW1 is off as described above. Then, the lens CPU 301 stops the shake correction control. In the step S5014, the power supplied to the coil 10 and the adsorption coil 11 is cut off to hold the correction optical unit 307 (correction lens L) in the predetermined position (optical axis center position).

After the end of the foregoing operation, the process proceeds to a step S5015, in which the lens CPU 301 resets the internal timer to start the operation again. In steps S5016 and S5017, judgment is made as to whether the switch SW1 becomes on again or not within a predetermined time T2. If the switch SW1 becomes on again within the predetermined time T2 after the stop of the shake correction, the process proceeds to a step S5018.

In the step S5018, the camera CPU 201 controls driving of the photometric circuit 205 to detect a luminance of the subject, and controls driving of the focus detection circuit 208 to detect a focus adjustment state of the photographing optical system. The lens CPU 301 controls driving of the driving circuit 308a of the focusing unit 308 based on a command from the camera CPU 201 to move the focusing lens 308b to a predetermined focusing position. Further, the lens CPU 301 controls driving of the correction optical unit 307 to unlock the correction lens L as described above.

In this case, since the vibration detection by the vibration detection unit 304 continues, the process proceeds to the step S5009 to immediately drive the correction lens L based on a target value signal and an output (data regarding a current position of the correction lens L) of the position detection sensor, thereby starting the shake correction operation again. Thereafter, an operation similar to the above is repeated.

By the aforementioned process, when the switch SW1 becomes on again after it becomes off from on by photographer's operation of the releasing operation member 204, the vibration detection unit 304 is started each time the switch SW1 becomes on. Accordingly, it is possible to eliminate the problem in that the process must stand by until the output of the vibration detection unit 304 is stabilized.

On the other hand, if the switch SW1 does not become on within the predetermined time T2 after the stop of the shake correction operation in the step S5016, the process proceeds to a step S5019 to stop the vibration detection (stop the operation of the vibration detection unit 304). Subsequently, the process returns to the step S5002, and stand by until the switch SW1 becomes on.

If an IS operation is not selected in the step S5003, the process proceeds to a step S5020, and the camera CPU 201 executes a photometric operation and detects a focus adjustment state through the photometric circuit 205 and the focus detection circuit 208. Then, the lens CPU 301 executes a focusing operation to move the focusing lens 308b to a focusing position in accordance with a detection result of the focus adjustment state.

Then, in a step S5021, the camera CPU 201 judges whether the switch SW2 is on or not. If the switch SW2 is in an off state, the process proceeds to a step S5023 to judge whether the switch SW1 is on or not again. If the switch SW1 is not on, the process returns to the step S5002, and stands by until the switch SW1 becomes on.

On the other hand, if the switch SW2 is not on in the step S5021 while the switch SW1 is on in the step S5023, the process returns to the step S5021. Then, upon detection of the on state of the switch SW2 in the step S5021, the process proceeds to a step S5022, and the lens CPU 301 controls the stop unit 309 (drives the stop member 309b), and the camera CPU 201 drives the exposure circuit 206 to execute an exposure operation.

Preceding to the step S5023, the camera CPU 201 judges an on/off state of the switch SW1, and the process returns to the step S5002 or the step S5021 based on a result of the judgment.

According to the camera system of this embodiment, the aforementioned series of operations are repeated until the power supply switch 203 becomes off. When the switch becomes off, the communication between the camera CPU 201 and the lens CPU 301 is stopped, and the power supply from the camera 200 to the interchangeable lens 300 is stopped.

FIGS. 3A and 3B are diagrams illustrating characteristics of the image blur correction apparatus according to this embodiment: FIG. 3A showing a gain (amplitude ratio of the output signal dOUT to the input signal dIN), and FIG. 3B showing a phase (phase delay of the output signal dOUT to the input signal dIN).

Referring to FIG. 3A, reference numeral 101 denotes an example of gain characteristic in case of a small influence of a force of gravity applied on the correction optical unit 307, showing gain characteristic when an amplification gain value corresponding to a gravity detection value is set from the amplification gain table prestored in the memory 301a of the lens CPU 301 based on the output (gravity detection value) of the posture sensor 305 in the horizontal state (state in which a gravity direction is a direction A in FIG. 4) of the image blur correction apparatus (camera system).

Reference numeral 102 denotes an example of gain characteristic in case of a large influence of a force of gravity applied to the correction optical unit 307, showing gain characteristic in the case of a conventional amplification gain in the upward facing state (state in which a gravity direction is a direction B in FIG. 4) of the image blur correction apparatus.

Reference numeral 107 denotes an example of gain characteristic in case of a large influence of a force of gravity applied to the correction optical unit 307, showing gain characteristic when amplification gain value corresponding to the gravity detection value is set from the amplification gain table prestored in the memory 301a of the lens CPU 301 based on the output (gravity detection value) of the posture sensor 305 in the upward facing state (state in which the gravity direction is the direction B in FIG. 4) of the image blur correction apparatus.

Referring to FIG. 3B, reference numeral 103 denotes an example of phase characteristic in case of a small influence of a force of gravity applied on the correction optical unit 307, showing phase characteristic when an amplification gain value corresponding to a gravity detection value is set from the amplification gain table prestored in the memory 301a of the lens CPU 301 based on the output (gravity detection value) of the posture sensor 305 in the horizontal state (state in which the gravity direction is the direction A in FIG. 4) of the image blur correction apparatus.

Reference numeral 104 denotes an example of phase characteristic in case of a large influence of a force of gravity applied to the correction optical unit 307, showing phase characteristic in the case of a conventional amplification gain in the upward facing state (state in which the gravity direction is the direction B in FIG. 4) of the image blur correction apparatus. Incidentally, characteristic in a downward facing state of the image blur correction apparatus are similar to those in the upward facing state.

Reference numeral 108 denotes an example of phase characteristic in case of a large influence of a force of gravity applied to the correction optical unit 307, showing phase characteristic when amplification gain value corresponding to the gravity detection value is set from the amplification gain table prestored in the memory 301a of the lens CPU 301 based on the output (gravity detection value) of the posture sensor 305 in the upward facing state (state in which the gravity direction is the direction B in FIG. 4) of the image blur correction apparatus.

As apparent from the drawings, when the amplification gain value corresponding to the gravity detection value is set, a fictional force is increased between the support pins 3 for supporting the correction optical system (correction lens L and support frame 1) and the cam hole 4a disposed in the base board 4. Thus, as can be understood from the equations (1) and (2), by increasing a force factor K by an amount corresponding to an increase of a term C of the frictional force, a resonance frequency is shifted toward a high frequency side, and a gain is suppressed. Therefore, driving characteristic of the image blur correction apparatus in a normal use area become similar to those in the case of a small influence of a force of gravity, and good driving characteristics can be obtained.

FIG. 9 is a view showing a structure of an acceleration sensor as an example of the posture sensor 305 for detecting a gravity direction. FIG. 10 is a view showing a relation between a detection axis of the acceleration sensor of FIG. 9 and a force of gravity. Here, the acceleration sensor is used to detect a posture.

According to a principle of the acceleration sensor, generally, a weight is mounted to a sensor base through proper spring and damper systems, and a displacement of the weight with respect to the sensor base is converted into an electric signal. Depending on mechanisms of converting weight displacements into electric signals, there are a piezoelectric method, a dynamic electric method, a photoelectric method, a strain resistance method, a capacitance method, a servo method, and the like. Acceleration sensors of various sizes, structures, and characteristics have conventionally been developed in accordance with application purposes.

The acceleration sensor shown in FIG. 9 is a semiconductor acceleration sensor 401 of a strain resistance type, and manufactured by processing a silicon wafer or the like through a semiconductor process. A weight 402 is supported in cantilever on a frame 404 by a beam 403. A piezoelectric resistance element 405 is disposed on the beam 403, and glass substrates 406 and 407 are bonded to both surfaces of the frame 404. A displacement of the weight 402 is converted into an electric signal by the piezoelectric resistance element 405, and output from a circuit (not shown).

Displacement directions of weights in many acceleration sensors are almost linear, and such a displacement direction is referred to as a detection axis or a maximum sensitivity axis. As long as the detection axis is not arranged to be completely orthogonal to a gravity acceleration direction (arrangement in which the detection axis is horizontal), a DC component by gravity acceleration is output. In other words, when the detection axis of the acceleration sensor 401 is at an angle θ which is not 90° to a direction of a force of gravity G as shown in FIG. 10, the acceleration sensor 401 becomes sensitive to a gravity component (Gcosθ) parallel to the detection axis, and a sensor output becomes a DC component corresponding to the angle θ in accordance with tilting of the sensor 401.

By using the acceleration sensor 401, it is possible to finely detect the posture of the camera (camera system).

The configuration of the camera system of this embodiment has been described. However, the present invention is not limited to the configuration of this embodiment, and it is needless to say that configurations capable of achieving functions described in claims and functions of this embodiment can be employed.

That is, according to the embodiments described above, the semiconductor acceleration sensor of the strain resistance type is used as the sensor for detecting the gravity direction of the correction optical unit 307. However, the present invention is not limited to this sensor, and the acceleration sensors of the other types described above can be used. Software and hardware configurations of this embodiment can be properly replaced by others.

The present invention can be applied to an optical apparatus such as a single lens reflex camera, a lens shutter camera, or a video camera. Further, the invention according to aspects of the present invention or the configurations of this embodiment may constitute one device as a whole, be separated from/connected to other devices, or be elements which constitute a device. For example, a vibration detection unit may be disposed in the camera, and components of the other shake correction apparatus may be disposed in the interchangeable lens.

Additionally, the correction optical system of this embodiment has been described by way of the shift optical system which moves the correction lens L (optical member) in a plane vertical to the optical axis. However, light beam changing means such as a variable apex angle prism for correcting an image blur by changing a titling angle of the prism with respect to an optical axis of optical members positioned in both ends may be used.

According to the invention, by changing the driving characteristics (e.g., gain characteristic and phase characteristic) of the driving mechanism in accordance with the output of the posture detection means, it is possible to prevent deterioration of the driving characteristic of the apparatus caused by a uniform increase of the amplification gains irrespective of the posture of the image blur correction apparatus as in the conventional case.

In other words, the driving signal for driving the driving mechanism is generated based on the shake signal obtained from the output of the vibration detection means and the amplification gain data, and the value of the amplification gain data is changed according to an output of the posture detection means. Thus, it is possible to obtain good driving characteristic.

Specifically, good driving characteristic can be obtained by increasing the value of the amplification gain data as the resistance force generated in the driving mechanism against the driving of the optical element is larger with respect to the output of the posture detection means. When the resistance force is small, the value of the amplification gain data needs not be increased, and it is possible to suppress an increase of a gain peak caused by the increased value of the amplification gain data in the horizontal state (state in which the resistance force is small) of the image blur correction apparatus which occurs in the conventional case.

The memory is disposed to store the amplification gain value in accordance with the posture, and the amplification gain value is read from the memory by the control means in accordance with the output of the posture detection means. Thus, it is possible to easily generate a diving signal in accordance with the image blur correction apparatus.

As many apparently widely different embodiments of the present invention can be make without departing from the spirit and scope thereof, it is to be understood that the invention is not limited to the specific embodiments thereof except as defined in the claims.

This application claims priority from Japanese Patent Application No. 2003-412525 filed Dec. 10, 2003, which is hereby incorporated by reference herein.

1. An image blur correction apparatus for correcting an image blur caused by a vibration by driving an optical element, comprising:
a vibration detector for detecting the vibration;
a diving mechanism for driving the optical element;
a controller for controlling the driving mechanism based on an output of the vibration detector; and
a posture detector for detecting a posture of the apparatus,
wherein the controller changes a driving characteristic of the driving mechanism in accordance with an output of the posture detector.

2. An image blur correction apparatus according to claim 1, wherein the posture detector detects the posture of the apparatus in a gravity direction.

3. An image blur correction apparatus according to claim 1, wherein the controller generates a driving signal for driving the driving mechanism based on a vibration signal obtained from the output of the vibration detector and amplification gain data, and changes a value of the amplification gain data in accordance with the output of the posture detector.

4. An image blur correction apparatus according to claim 1, wherein the controller increases a value of amplification gain data as a resistance force generated in the driving mechanism against driving of the optical element is larger with respect to the output of the posture detector.

5. An image blur correction apparatus according to claim 1, further comprising a memory which stores an amplification gain value according to the posture of the apparatus,
wherein the controller reads the amplification gain value according to the output of the posture detector from the memory.

6. An optical apparatus for correcting an image blur caused by a vibration by driving an optical element, comprising:
a driving mechanism for driving the optical element;
a controller for controlling the driving mechanism based on an output of a vibration detector which detects the vibration; and
a posture detector for detecting a posture of the optical apparatus,
wherein the controller changes a driving characteristic of the driving mechanism in accordance with an output of the posture detector.
